(19) United States
(12) Patent Application Publication
(10) Pub. No.: US 2026/0132007 A1
(43) Pub. Date: May 14, 2026

(54) PORTABLE MULTISTAGE LIFTING MACHINE

(71) Applicant: JPW Industries Inc., LaVergne, TN (US)

(72) Inventors: Timothy Gale Birdwell, Lafayette, TN (US); Charles Weber, Onalaska, WI (US); Gary Lynn Goette, Albert Lea, MN (US)

(21) Appl. No.: 19/390,183

(22) Filed: Nov. 14, 2025

Related U.S. Application Data
(60) Provisional application No. 63/720,537, filed on Nov. 14, 2024.

(51) Int. Cl. B66F 9/06

(52) U.S. Cl. CPC B66F 9/06

(57) ABSTRACT

A portable lifting machine is disclosed for lifting and transporting loads. The machine may include a base supporting a mast having a plurality of telescoping portions pivotally attached to the base for movement between vertical, angled, and stored positions. A load lifting assembly, including a lift support and a lifting mechanism such as a winch, may be operable to raise and lower the telescoping portions. A pair of base legs and a pair of outrigger legs may be pivotally coupled to the base to provide adjustable stability, with each leg positionable and lockable in multiple orientations. The base may include frame rails with wheels at opposite ends to permit rolling movement and forklift engagement. Dust shields and a mast hold-down mechanism may protect and secure the telescoping portions during use or transport. The lifting machine provides a compact, reconfigurable structure suitable for safe lifting in various environments.

### CROSS-REFERENCES TO RELATED APPLICATIONS

This application claims priority to U.S. Provisional Patent Application Ser. No. 63/720,537 filed Nov. 14, 2024, the entirety of which is incorporated by reference herein.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### BACKGROUND OF THE INVENTION

The present invention relates to material handling and lifting equipment.

More particularly, the present disclosure relates to small machines, such as multi-stage material lifts, for lifting loads at work sites. Multi-stage material lifts are widely used in a variety of industries, including warehouses, construction sites, retail spaces, and manufacturing facilities, for lifting and transporting heavy loads to elevated positions. These devices typically feature a platform, load-bearing surface, or forks that can be raised and lowered using a series of telescoping or interlocking stages. The lifting mechanism allows operators to access hard-to-reach areas, load or unload materials, and perform tasks such as equipment installation, maintenance, and stock organization.

While multi-stage lifts offer significant advantages in material handling and vertical access, there are several challenges associated with existing lift designs that limit their practicality and efficiency in certain environments. One of the primary limitations of conventional multi-stage material lifts is their size, particularly in terms of their inability to fit through standard doorways. Doorways in commercial and residential buildings are typically limited to a width of 30 to 36 inches, and many existing lifts have base widths, frame structures, or lifting components that exceed these dimensions. As a result, these lifts cannot be easily transported between rooms, hallways, or areas with restricted access.

The inability of these lifts to pass through doorways presents significant challenges in environments where narrow or confined spaces are common, such as in construction sites, office buildings, warehouses with narrow aisles, or retail stores. Operators are often forced to rely on inefficient methods for moving material, such as manual handling or the use of other machinery like forklifts or cranes, which may not be suitable for smaller spaces. These workarounds not only reduce operational efficiency but can also pose safety risks to operators, particularly when lifting heavy or awkward loads.

In addition to the issue of fitting through doorways, many existing multi-stage material lifts are not designed with compact storage in mind. Traditional lifts, particularly those with larger frames or fixed structures, can be cumbersome to store when not in use. These lifts often require significant floor space and cannot be easily retracted or disassembled to reduce their size for storage. As a result, companies and operators must allocate substantial storage areas, which may be at a premium in facilities with limited space. This lack of compactness when storing the lift makes it difficult to maintain a tidy, organized workspace, and can lead to inefficient use of valuable storage or operational areas.

Moreover, the size and bulk of existing multi-stage lifts often make them more difficult to transport, whether between floors or to different job sites. Without an easy way to compact the lift, transportation and handling costs can be higher, especially for companies that need to move the equipment frequently or to different locations. The lack of storage and transport efficiency is particularly problematic in industries where portability and flexibility are critical for smooth operations.

What is needed then are improvements in multi-stage material lifts for lifting heavy loads.

### BRIEF SUMMARY

This Brief Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In view of at least some of the above-referenced limitations in conventional multi-stage material lifts, an exemplary object of the present disclosure may be to provide a new and improved portable lifting machine that combines compactness, portability, and reconfigurable lifting capability within a single device. The portable lifting machine may include a base that is rollable using wheels, a mast comprising a plurality of telescoping portions pivotally attached to the base at a pivot point, and a load-lifting assembly attached to the mast and selectively operable to raise or lower a load using one or more of the telescoping portions. By enabling the mast to pivot between vertical, angled, and stored positions, and by allowing the overall footprint to fit through standard doorways, the disclosed lifting machine may offer improved maneuverability, ease of transport, and compact storage relative to conventional material lifts, thereby enhancing operational efficiency across diverse work environments.

In a particular embodiment, an exemplary portable lifting machine for lifting a load as disclosed herein may include a base, a mast, and a load lifting assembly. The mast may comprise a plurality of telescoping portions. At least one of plurality of telescoping portions may be pivotally attached to the base at a pivot point. The load lifting assembly may be attached to the mast and selectively operable to lift the load using one or more of the plurality telescoping portions.

In an exemplary aspect according to the above-referenced embodiment, the portable lifting machine may further include a pair of base legs pivotally coupled to the base on opposite sides of the mast. Each of the pair of base legs may include a distal end with a wheel.

In an exemplary aspect according to the above-referenced embodiment, each of the pair of base legs may be movable between and lockable in a front position and a rear position. The front position may extend forward of the mast and the rear position may extend rearward of the mast.

In an exemplary aspect according to the above-referenced embodiment, the portable lifting machine may further include a counterweight couplable to the pair of base legs when the pair of base legs are in the rear position.

In an exemplary aspect according to the above-referenced embodiment, each of the pair of base legs may be couplable to an upper surface of the base using an omnidirectional pivot assembly.

In an exemplary aspect according to the above-referenced embodiment, each of the pair of base legs includes a first portion couplable to the base at a proximal end, a second portion extending perpendicular from a distal end of the first portion, and a third portion extending perpendicularly from the second portion. The first portion and the third portion may be parallel and offset from each other.

In an exemplary aspect according to the above-referenced embodiment, the portable lifting machine may further include a pair of outrigger legs rotatably coupled to the base on opposite sides of the mast. Each of the pair of outrigger legs may include a distal end with a wheel.

In an exemplary aspect according to the above-referenced embodiment, each of the pair of outrigger legs may be movable between and lockable in a forward position, a rearward position, and an angled position. The forward position may extend forward of the mast and the rearward position may extend rearward of the mast.

In an exemplary aspect according to the above-referenced embodiment, each of the pair of outrigger legs may be couplable to respective side surfaces of the base using a bidirectional pivot.

In an exemplary aspect according to the above-referenced embodiment, the base may further include a pair of frame rails positioned on opposite sides of the mast and a plurality of wheels. Each of the plurality of wheels may be coupled at opposite ends of each of the pair of frame rails.

In an exemplary aspect according to the above-referenced embodiment, each of the pair of frame rails may comprise a fork passageway defined therethrough. The fork passageway may be configured to receive a fork of a forklift.

In an exemplary aspect according to the above-referenced embodiment, the plurality of wheels may comprise a pair of rollers coupled at respective front ends of the pair of frame rails and a pair of swivel wheels coupled at respective rear ends of the pair of frame rails.

In an exemplary aspect according to the above-referenced embodiment, the mast may include a front side and a rear side and the load lifting assembly may include a lift support for lifting the load and a lifting mechanism for manipulating the plurality of telescoping portions. The support may be coupled to the front side of the mast and the lifting mechanism may be coupled to the rear side of the mast.

In an exemplary aspect according to the above-referenced embodiment, the lifting mechanism comprises a winch configured to be actuated using a handle, a motor, or a drill.

In an exemplary aspect according to the above-referenced embodiment, the portable lifting machine may further include at least one support strut coupled between the base and the mast.

In an exemplary aspect according to the above-referenced embodiment, the portable lifting machine may further include a support frame coupled to one of the plurality of telescoping portions of the mast. The support frame may be configured to receive the at least one support strut for positioning the mast in one or more discrete positions relative to the base.

In an exemplary aspect according to the above-referenced embodiment, the one or more discrete positions may include a vertical position with the mast positioned substantially vertical relative to the base and a stored position with the mast positioned substantially parallel to the base.

In an exemplary aspect according to the above-referenced embodiment, the support frame may include a guide structure and a collar movable along the guide structure for positioning the mast in the one or more discrete positions. The at least one support strut may be coupled to the collar.

In an exemplary aspect according to the above-referenced embodiment, the portable lifting machine may further include a plurality of dust shields coupled to exterior surfaces of the plurality of telescoping portions. The plurality of dust shields may at least partially cover upper openings of the plurality of telescoping portions.

In an exemplary aspect according to the above-referenced embodiment, the portable lifting machine may further include a mast hold-down mechanism extending from the base. The mast hold-down mechanism may be configured to engage at least one of the plurality of telescoping portions for preventing movement of the plurality of telescoping portions.

In another particular embodiment, an exemplary portable lifting machine for lifting a load as disclosed herein may include a base, a mast, a load lifting assembly, at least one support strut, and a support frame. The mast may comprise a plurality of telescoping portions. The load lifting assembly may be attached to the mast and may be operable to lift the load using one or more of the plurality of telescoping portions. The at least one support strut may be coupled between the base and the mast. The support frame may be coupled to one of the plurality of telescoping portions of the mast. The support frame may be configured to receive the at least one support strut for positioning the mast in one or more discrete positions relative to the base. The one or more discrete positions may include a vertical position and a stored position. The support frame may comprise a guide structure and a collar movable along the guide structure for positioning the mast in the one or more discrete positions. The at least one support strut may be coupled to the collar.

In a particular embodiment, an exemplary portable lifting machine for lifting a load as disclosed herein may include a base, a mast coupled to the base, and a fork passageway defined through the base. The fork passageways configured to receive forks of a forklift for lifting and transporting the portable lifting machine.

In an exemplary aspect according to the above-referenced embodiment, the base may include a pair of frame rails positioned on opposite sides of the mast. The fork passageway may be defined through each of the pair of frame rails.

In a particular embodiment, an exemplary portable lifting machine for lifting a load as disclosed herein may include a base, a mast, and a pair of outrigger legs. The mast may extend upward from the base. The pair of outrigger legs may be pivotally coupled to the base on opposite sides of the mast. Each of the pair of outrigger legs may be movable in a substantially horizontal plane between a forward position, a rearward position, and an angled position.

In a particular embodiment, an exemplary portable lifting machine for lifting a load as disclosed herein may include a base, a pair of base legs, and a counterweight. The pair of base legs may be pivotally coupled to the base on opposite sides of a mast. Each of the pair of base legs may include a distal end with a wheel and being movable between a front position and a rear position. The counterweight may be selectively couplable to the pair of base legs when in the rear position to stabilize the portable lifting machine during lifting or transport operations.

In a particular embodiment, an exemplary portable lifting machine for lifting a load as disclosed herein may include a mast, a load lifting assembly, and a plurality of dust shields. The mast may comprise a plurality of telescoping portions. The load lifting assembly may be attached to the mast and operable to lift the load using one or more of the plurality of telescoping portions. The plurality of dust shields may be secured to exterior surfaces of the plurality of telescoping portions. The plurality of dust shields may at least partially cover upper openings of the telescoping portions to prevent ingress of dust or debris into the plurality of telescoping portions.

Numerous other objects, advantages and features of the present disclosure will be readily apparent to those of skill in the art upon a review of the following drawings and description of a preferred embodiment.

### BRIEF DESCRIPTION OF THE DRAWINGS

FIG. 1 is a rear perspective view of an embodiment of a portable lifting machine with a mast in a vertical position with base legs in a front position in accordance with the present disclosure.

FIG. 2 is a front perspective view of the portable lifting machine of FIG. 1 in accordance with the present disclosure.

FIG. 3 is a side elevation view of the portable lifting machine of FIG. 1 in accordance with the present disclosure.

FIG. 4 is a rear perspective view of the portable lifting machine of FIG. 1 with base legs in a rear position in accordance with the present disclosure.

FIG. 5 is a front perspective view of the portable lifting machine of FIG. 4 in accordance with the present disclosure.

FIG. 6 is a rear perspective view of the portable lifting machine of FIG. 1 with the mast in a stored position in accordance with the present disclosure.

FIG. 7 is a front perspective view of the portable lifting machine of FIG. 6 in accordance with the present disclosure.

FIG. 8 is a front perspective view of the portable lifting machine of FIG. 1 outrigger legs in a forward position in accordance with the present disclosure.

FIG. 9 is an enlarged rear perspective view of a support frame and support struts of the portable lifting machine of FIG. 1 in accordance with the present disclosure.

FIG. 10 is an enlarged front perspective view of an upper end of the mast of the portable lifting machine of FIG. 1 in accordance with the present disclosure.

FIG. 11 is an enlarged front perspective view of a lower end of the mast of the portable lifting machine of FIG. 1 in accordance with the present disclosure.

FIG. 12 is an enlarged front perspective view of the base of the portable lifting machine of FIG. 1 in accordance with the present disclosure.

FIG. 13 is a front perspective view of the portable lifting machine of FIG. 6 with rollers extending from the base in accordance with the present disclosure.

FIG. 14 is a side elevation view of the potable lifting machine of FIG. 13 in a tilted orientation relative to a support surface in accordance with the present disclosure.

FIG. 15 is a rear perspective view of another embodiment of a portable lifting machine in accordance with the present disclosure.

FIG. 16 is a rear perspective view of another embodiment of a portable lifting machine in accordance with the present disclosure.

### DETAILED DESCRIPTION

Reference will now be made in detail to embodiments of the present disclosure, one or more drawings of which are set forth herein. Each drawing is provided by way of explanation of the present disclosure and is not a limitation. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

Thus, it is intended that the present disclosure covers such modifications and variations as come within the scope of the appended claims and their equivalents. Other objects, features, and aspects of the present disclosure are disclosed in, or are obvious from, the following detailed description. It is to be understood by one of ordinary skill in the art that the present discussion is a description of exemplary embodiments only and is not intended as limiting the broader aspects of the present disclosure.

The words “connected”, “attached”, “joined”, “mounted”, “fastened”, and the like should be interpreted to mean any manner of joining two objects including, but not limited to, the use of any fasteners such as screws, nuts and bolts, bolts, pin and clevis, and the like allowing for a stationary, translatable, or pivotable relationship; welding of any kind such as traditional MIG welding, TIG welding, friction welding, brazing, soldering, ultrasonic welding, torch welding, inductive welding, and the like; using any resin, glue, epoxy, and the like; being integrally formed as a single part together; any mechanical fit such as a friction fit, interference fit, slidable fit, rotatable fit, pivotable fit, and the like; any combination thereof; and the like.

Unless specifically stated otherwise, any part of the apparatus of the present disclosure may be made of any appropriate or suitable material including, but not limited to, metal, alloy, polymer, polymer mixture, wood, composite, or any combination thereof.

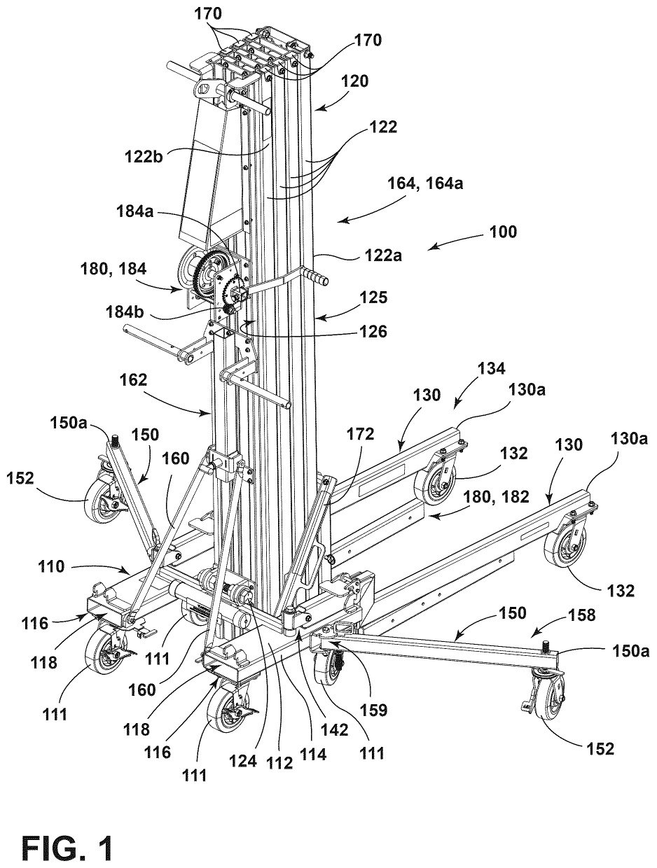

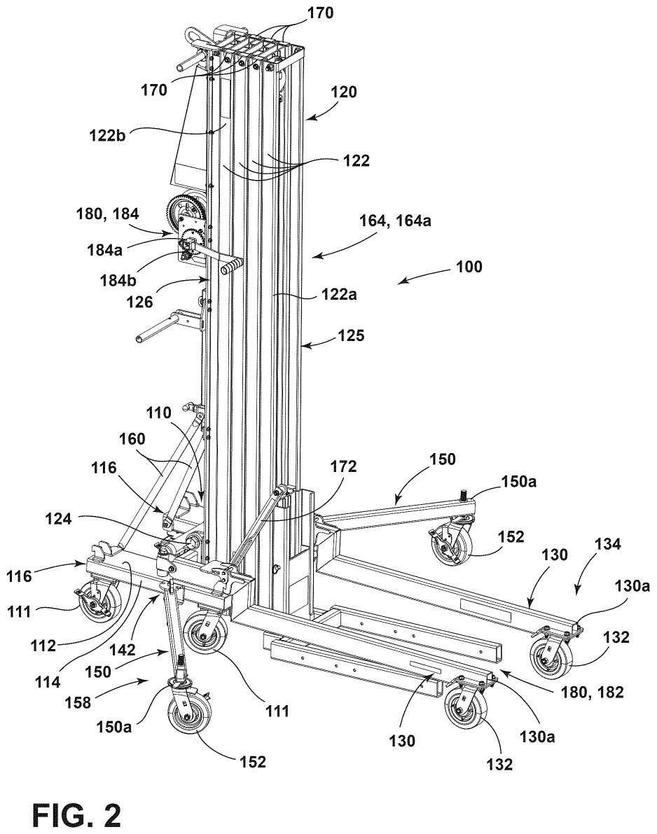

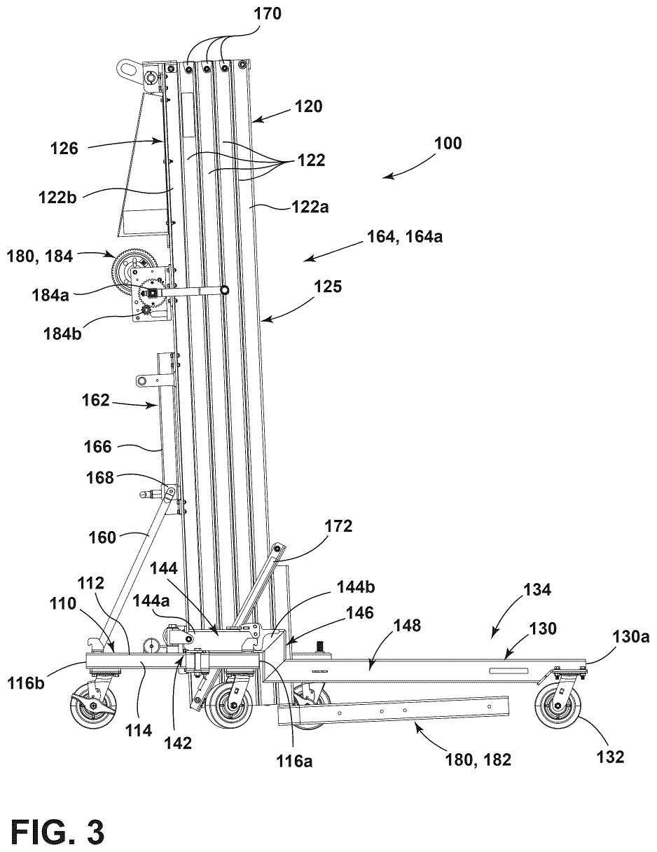

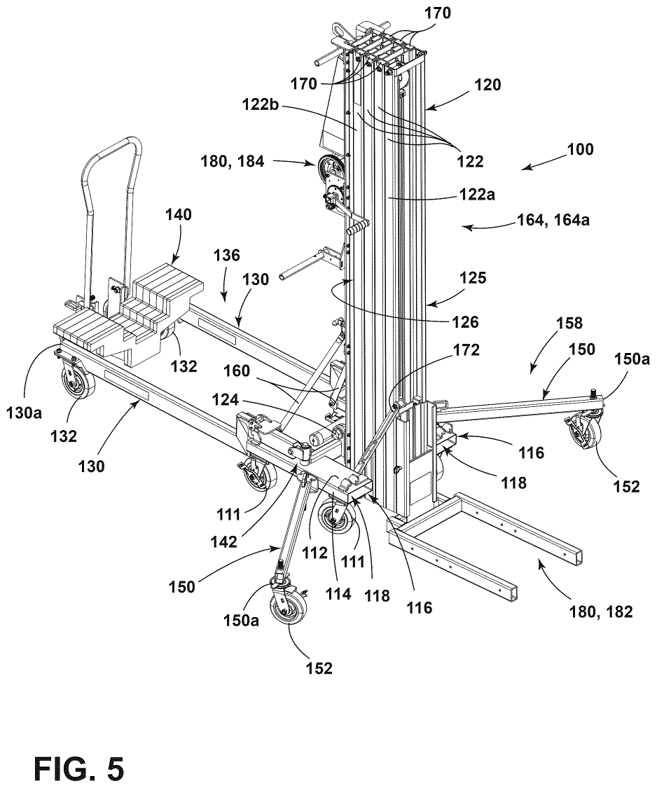

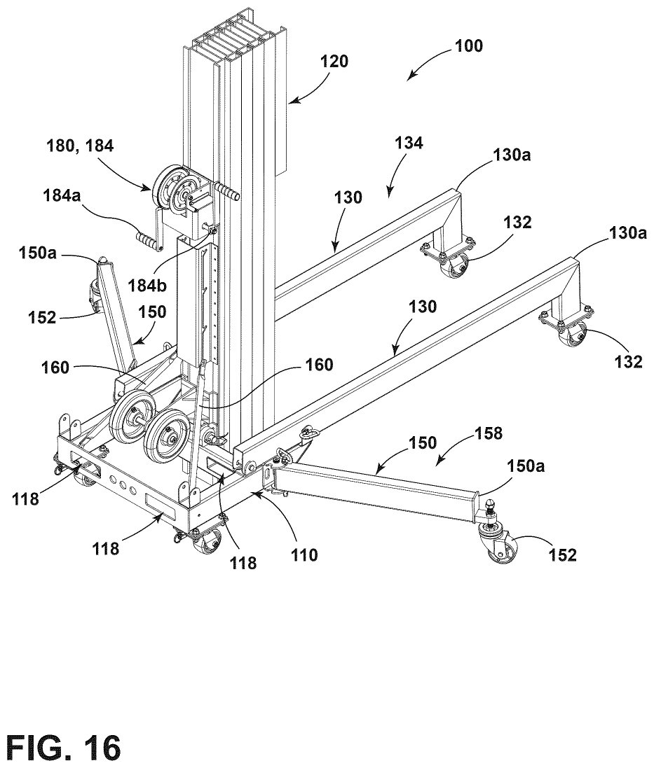

One aspect of the present disclosure, as shown in FIGS. 1-16, is a portable lifting machine 100 for lifting a load. The portable lifting machine 100 may include a base 110 that supports a mast 120 and provides mobility via a plurality of wheels 111. The base 110 may be formed of any suitable combination of plates, frame members, tubes, or beams configured to define a rigid structural element for supporting the mast 120. In some embodiments, the base 110 may generally be rectangular and includes a pair of frame rails 116 positioned on opposite sides of the mast 120. Each of the pair of frame rails 116 may include wheels 111 coupled at opposite ends 116a, 116b (shown in FIG. 3), such that the wheels 111 collectively support and enable rolling movement of the portable lifting machine 100. Each frame rail 116 may further define a fork passageway 118 (or fork pocket) configured to receive forks of a forklift, thereby allowing the entire machine 100 to be lifted and transported safely and efficiently. In certain optional embodiments, as illustrated in FIG. 16, the fork passageway 118 may be defined through the base 110 without the pair of frame rails 116.

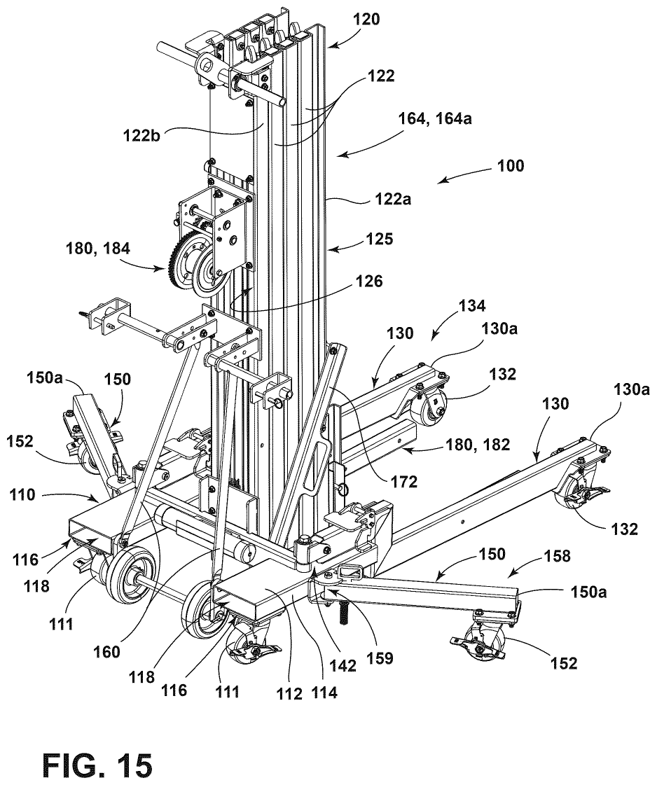

In certain optional embodiments, as illustrated in FIGS. 1-14, the mast 120 may be pivotally attached to the base 110 at a pivot point 124 to permit tilting movement. In other optional embodiments, as illustrated in FIG. 15, the mast 120 may be rigidly attached to the base 110, allowing for a simplified, non-tilting configuration suitable for applications where the mast is intended to remain vertical during operation and storage. The mast 120 may comprise a plurality of telescoping portions 122 configured to extend and retract relative to one another for raising or lowering a load. At least one of the telescoping portions 122 may be pivotally attached to the base 110 at the pivot point 124, which may include a pin, shaft, or axle enabling controlled rotation of the mast 120 between upright, angled, and stored orientations. The mast 120 may include a front side 125 and a rear side 126. The portable lifting machine 100 may further include a load lifting assembly 180 coupled to the mast 120 and selectively operable to lift the load using one or more of the plurality of telescoping portions 122. The load lifting assembly 180 may include a lift support 182 coupled on the front side 125 (e.g., to a forwardmost one 122a of the plurality of telescoping portions 122) and a lifting mechanism 184 on the rear side 126 (e.g., to a rearmost one 122b of the plurality of telescoping portions 122). The lift support 182 may take the form of forks, a platform, a boom, a clamp, or a suction device, depending on the intended use.

In certain embodiments, the lifting mechanism 184 may comprise a winch connected to the telescoping portions 122 through pulleys and cables. The winch may be actuated manually by a handle, electrically by a motor, or mechanically by a drill through a socket adapter. A self-locking brake or ratchet may be incorporated to hold the telescoping portions 122 in position during lifting and lowering operations. In certain optional embodiments, the winch may be a dual-input design configured to be driven either manually via a handle or mechanically via a powered drill input. A secondary gear-reduction stage may be positioned between the manual crank input 184a and the drill input 184b (shown in FIGS. 1-3) to provide torque multiplication for the drill operation while maintaining a suitable hand-cranking speed for fine control. In one exemplary configuration, the manual crank input 184a may employ a first gear-reduction ratio of approximately 4.8:1, while the drill input 184b may include a second gear-reduction ratio of approximately 5:1, resulting in an overall effective gear reduction of about 20:1 for the drill drive input. This arrangement allows a user to perform fine manual adjustments at a moderate effort while still providing sufficient torque for powered lifting of heavier loads using a handheld drill.

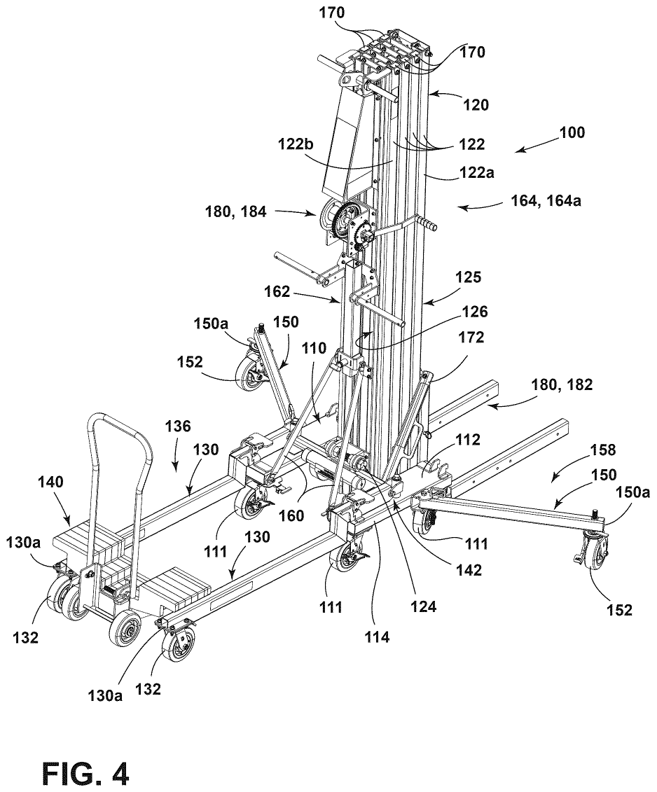

The portable lifting machine 100 may further include a pair of base legs 130 pivotally coupled to the base 110 on opposite sides of the mast 120. The pair of base legs 130 may provide additional support during lifting operations or transport. Each base leg 130 may include a distal end 130a with a wheel 132 coupled thereto for ground engagement. Each base leg 130 may be movable between and lockable in a front position 134 (shown in FIGS. 1-3) and a rear position 136 (shown in FIGS. 4-7). The front position 134 may feature each base leg 130 extending forward of the mast 120 to stabilize the machine 100 during load lifting, while the rear position 136 may feature each base leg 130 extending rearward of the mast 120 to reduce the footprint when the mast 120 is stored or to accommodate a counterweight 140 when lifting loads in spaces that do not permit the base legs 130 to extend in the front position 134. The counterweight 140 may be selectively attached to the base legs 130 when in the rear position 136 to enhance stability and prevent tipping when lifting heavier loads in tight spaces. As illustrated in FIGS. 4-7, the counterweight 140 may include a foldable handle and wheels. When coupled to the base legs 130 of the portable liftin machine 100, the handle may be manipulated to assist in repositioning the portable lifting machine 100. Additionally, the handle may enable the counterweight 140 to be easily moved via the wheels when disconnected from the base legs 130, much like a hand truck dolly.

Each base leg 130 may be coupled to an upper surface 112 of the base 110 through an omnidirectional pivot assembly 142, allowing the leg to pivot in multiple planes for versatile reconfiguration in tight or uneven spaces. As illustrated in FIG. 3, each base leg 130 may include a first portion 144 coupled to the base 110 at a proximal end 144a, a second portion 146 extending substantially perpendicular from a distal end 144b of the first portion 144, and a third portion 148 extending substantially perpendicular from the second portion 146 away from the first portion 144 such that the first and third portions 144, 148 are generally parallel. The third portion 148 may have a length longer than the first portion 144. This multi-segment geometry may provide strength, stability, and compact folding capability, as well as clearance around the pair of frame rails 116 while maintaining a low center of gravity.

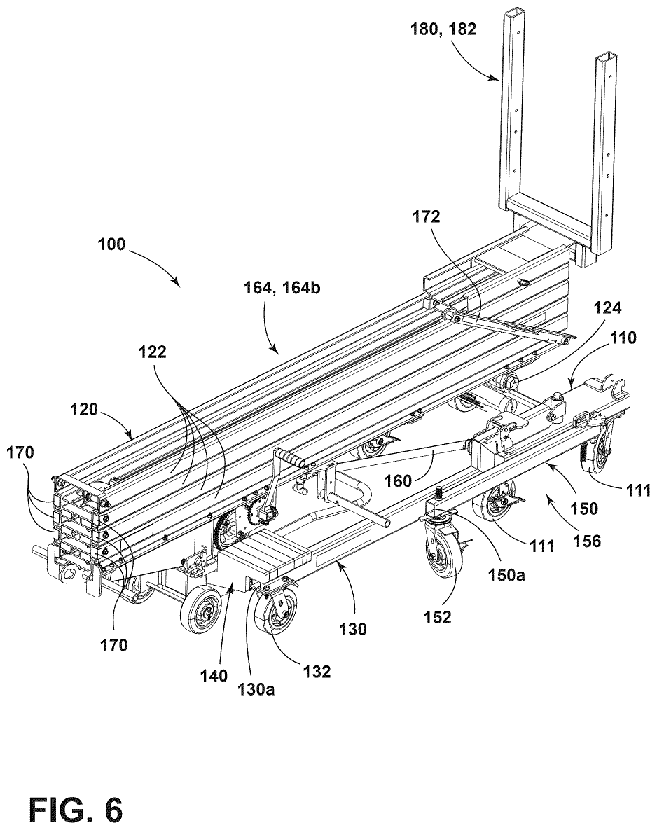

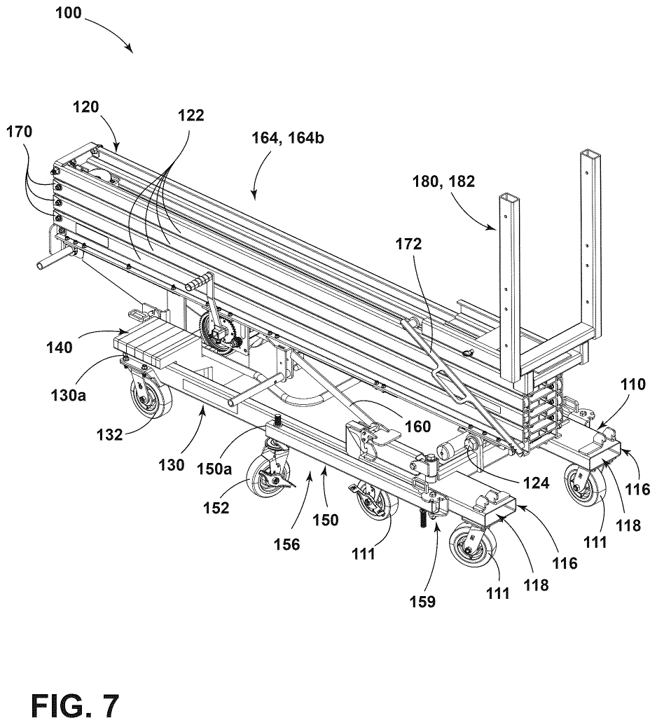

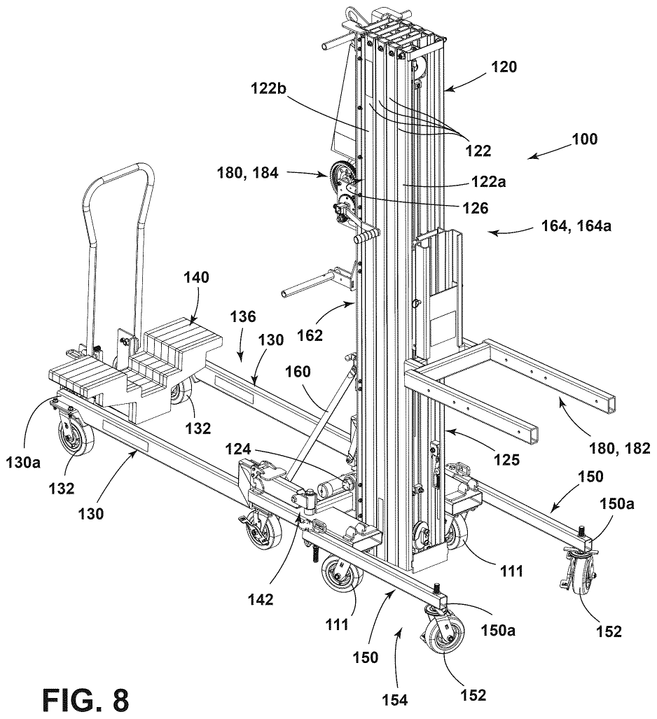

The portable lifting machine 100 may further include a pair of outrigger legs 150 rotatably coupled to the base 110 on opposite sides of the mast 120. Each outrigger leg 150 may include a distal end 150a with a wheel 152 coupled thereto. Each outrigger leg 150 may be movable between and lockable in at least a forward position 154 (shown in FIG. 8), a rearward position 156 (shown in FIGS. 6-7), and an angled position 158 (shown in FIGS. 1-2 and 4-5). In certain optional embodiments, each outrigger leg 150 may be movable in a substantially horizontal plane between the forward position 154, the rearward position 156, and the angled position 158. The outrigger legs 150 may be attached to side surfaces 114 of the base 110 via a bidirectional pivot 159, permitting controlled movement in both forward and rearward directions. The outrigger legs 150 may expand the effective footprint of the machine 100 to provide increased lateral stability when in the angled position 158.

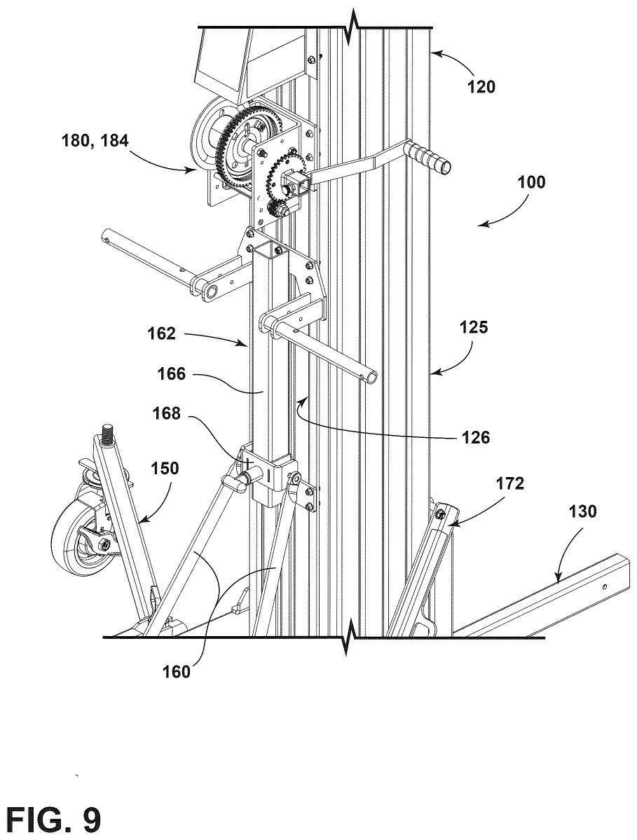

The portable lifting machine 100 may further include at least one support strut 160 coupled between the base 110 and the mast 120 to maintain mast alignment and support. A support frame 162 may be coupled to the rear side 126 of the mast 120 (e.g., at one of the telescoping portions 122) and may be configured to receive the at least one support strut 160 and position the mast 120 in one or more discrete positions 164 relative to the base 110. In some embodiments, as illustrated in FIG. 9) the support frame 162 may include a guide structure 166 and a collar 168 movable along the guide structure 166. The at least one support strut 160 may be coupled to the collar 168 so that sliding the collar 168 along the guide structure 166 locks the mast 120 in the desired discrete position 164. In certain optional embodiments, the support frame 162 may define a slot-and-notch or pin-receiving arrangement to secure the mast 120 at predefined angles relative to the base 110, which may aid in fitting the portable liftin machine through doorways or around tight turns.

The discrete positions 164 may include, for example, a vertical position 164a (shown in FIGS. 1-5 and 8) in which the mast 120 is positioned upright relative to the base 110, one or more angled positions where the mast 120 is inclined relative to the base 110, and a stored position 164b (shown in FIGS. 6-7) in which the mast 120 is substantially parallel to the base 110. The stored position 164b may facilitate stacking or nesting of multiple portable lifting machines 100 for transport or storage. In certain optional embodiments, a damper (not separately numbered) may optionally be positioned at the pivot point 124 to assist in smooth movement of the mast 120 between the positions 164a, 164b, and the intermediate angled positions, and further compensate for a weight of the mast 120 when transitioning between the positions. The damper may comprise gas springs, hydraulic dampers, viscous dampers, pneumatic dampers, spring-loaded dampers, rotary dampers, or dynamic dampers.

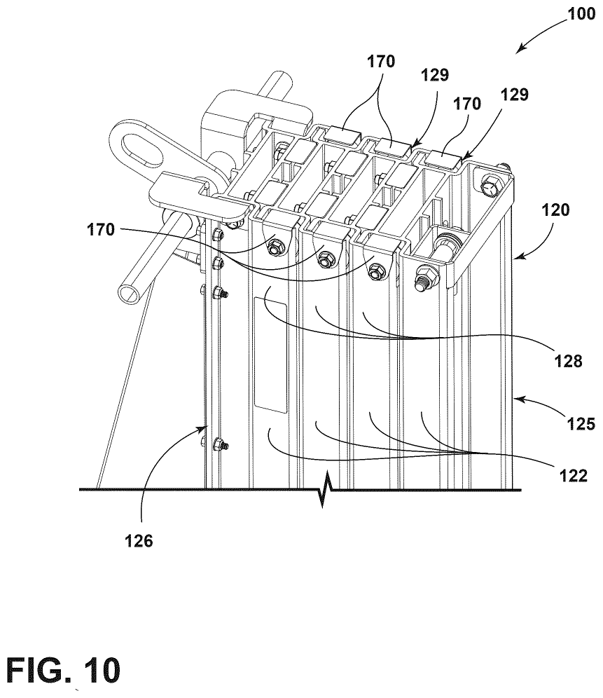

To protect the telescoping structure, as illustrated in FIG. 10, the portable lifting machine 100 may further include a plurality of dust shields 170 attached to the exterior surfaces 128 of the telescoping portions 122. The dust shields 170 may at least partially cover the upper openings 129 of the telescoping portions 122 to prevent ingress of dirt, dust, or other debris that could otherwise collect within the sliding interfaces of the telescoping portions 122. In certain embodiments, the telescoping portions 122 may define internal guide channels, bearing tracks, or pulley pathways through which cables of the lifting mechanism 184 are routed. Protecting these internal interfaces from contamination may reduce friction, prevent binding, and maintain consistent telescoping motion during lifting and lowering operations.

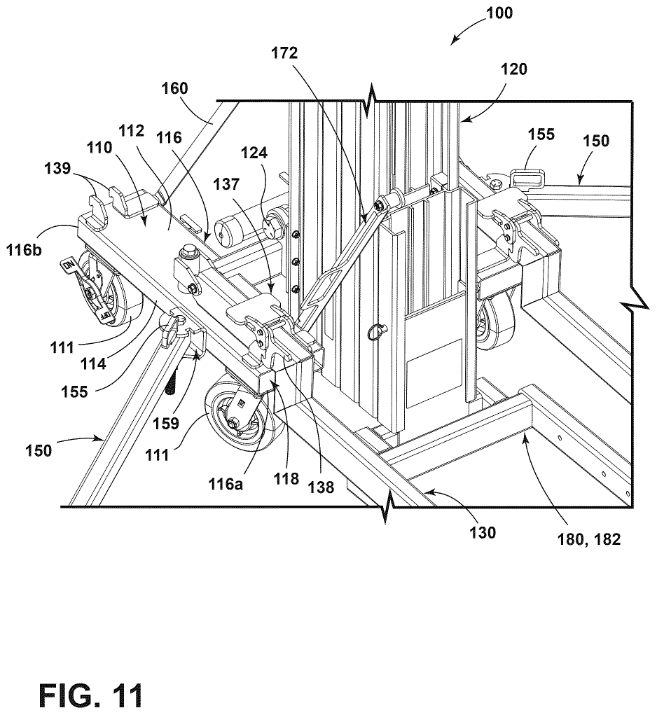

As illustrated in FIG. 11, the portable lifting machine 100 may further include a mast hold-down mechanism 172 configured to prevent unintended extension of the plurality of telescoping portions 122 during folding, transport, or storage even when tension on a lift cable is removed. In certain optional embodiments, the mast hold-down mechanism 172 may be coupled to a rearmost one 122a of the telescoping portions 122 (e.g., the portion including the pivot point 124) and may further be configured to engage a forwardmost one 122b of the telescoping portions 122 to prevent unintended extension of the plurality of telescoping portions 122. The mast hold-down mechanism 172 may include a distal end with an engagement member 174 configured to engage a channel of the forwardmost one 122b of the plurality of telescoping portions 122. The mast hold-down mechanism 172 may comprise a spring-biased pin, latch arm, or locking collar, and may be selectively releasable to permit telescoping movement when desired. In certain optional embodiments, the mast hold-down mechanism 172 may include a forward stop that prevents the mast hold-down mechanism 172 from pivoting forward past a forwardmost one 112b of the plurality of telescoping portions 122.

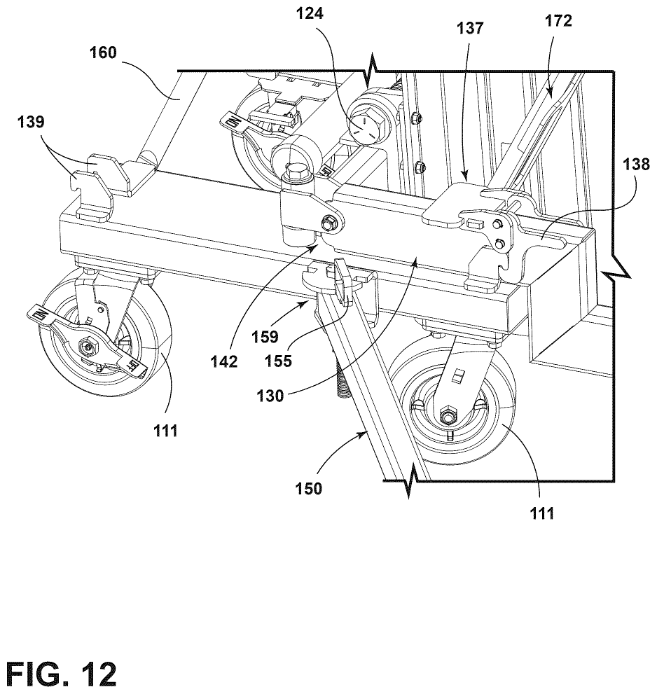

As illustrated in FIGS. 11-12, the pair of base legs 130 may be securable in the front position 134 and in the rear position 136 using a latch mechanism 137 having an over-center cam assembly 138 configured to selectively lock or release the base legs 130. In certain embodiments, the over-center cam assembly 138 may engage pairs of engagement members 139 coupled to the base 110 at opposite ends 116a, 116b. Each base leg 130 may be received between the corresponding pair of engagement members 139 to substantially eliminate lateral movement of the base legs 130, while the over-center cam assembly 138 may prevent vertical displacement when the base legs 130 are locked in position.

As further illustrated in FIGS. 11-12, the pair of outrigger legs 150 may be securable in the forward position 154, rearward position 156, or angled position 158 using spring-loaded keys 155. Each spring-loaded key 155 may be configured to lift upward to permit repositioning of the outrigger legs 150 and to automatically drop into one of a plurality of detent positions to secure each outrigger leg 150 in the selected position.

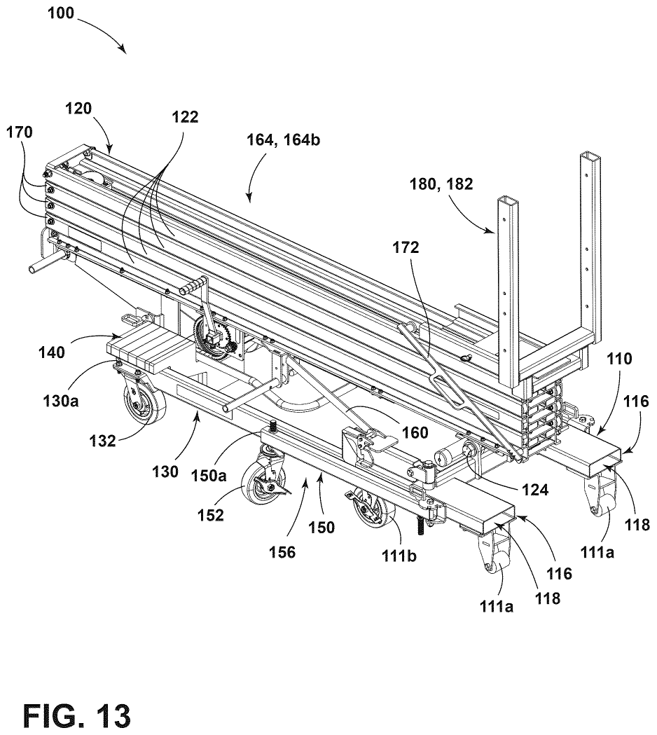

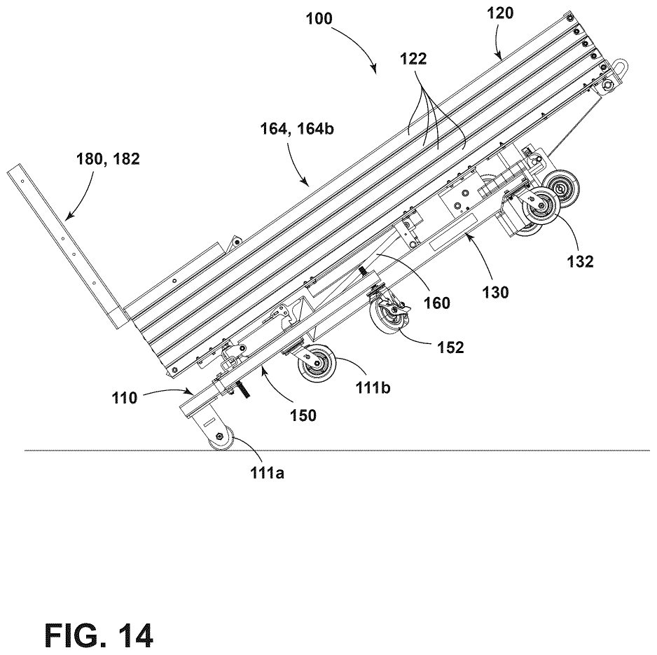

As illustrated in FIGS. 13-14, the plurality of wheels 111 coupled to the base 110 may include rollers 111a positioned at one end 116a (e.g., a front end) of the base 110 and swivel wheels 111b positioned at the opposite end 116b (e.g., a rear end) of the base 110. The rollers may define a pivot axis about which the portable lifting machine 100 may be tilted for lifting or maneuvering. When the portable lifting machine 100 is tilted, only the rollers may engage the ground surface, while the swivel wheels are lifted clear of the surface. This configuration may provide a stable two-point contact that allows the operator to safely control movement of the machine 100 without the risk of instability or unwanted rolling that could occur if the swivel wheels remained in contact with the ground. As illustrated in FIG. 14, the roller arrangement may permit the portable lifting machine 100 to be safely angled and guided into a transport vehicle, such as a truck bed, or onto a storage shelf.

Collectively, these components may provide a compact and reconfigurable lifting apparatus capable of multiple operational modes, including vertical lifting, angled or doorway operation, and fully stored transport mode, while maintaining a low center of gravity, enhanced stability, and ease of maneuverability for industrial, construction, and maintenance environments.

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment,” as used herein does not necessarily refer to the same embodiment, although it may.

Although embodiments of the present invention have been described in detail, it will be understood by those skilled in the art that various modifications can be made therein without departing from the spirit and scope of the invention as set forth in the appended claims.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

All of the compositions and/or methods disclosed and claimed herein may be made and/or executed without undue experimentation in light of the present disclosure. While the compositions and methods of this invention have been described in terms of the embodiments included herein, it will be apparent to those of ordinary skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

The previous detailed description has been provided for the purposes of illustration and description. Thus, although there have been described particular embodiments of a new and useful invention, it is not intended that such references be construed as limitations upon the scope of this disclosure except as set forth in the following claims.

What is claimed is:

1. A portable lifting machine for lifting a load, the portable lifting machine comprising:
a base;
a mast comprising a plurality of telescoping portions, at least one of plurality of telescoping portions pivotally attached to the base at a pivot point; and
a load lifting assembly attached to the mast and selectively operable to lift the load using one or more of the plurality telescoping portions.

2. The portable lifting machine of claim 1, further comprising:
a pair of base legs pivotally coupled to the base on opposite sides of the mast, each of the pair of base legs including a distal end with a wheel.

3. The portable lifting machine of claim 2, wherein:
each of the pair of base legs is movable between and lockable in a front position and a rear position, the front position extending forward of the mast and the rear position extending rearward of the mast.

4. The portable lifting machine of claim 3, further comprising:
an over-center cam assembly configured to engage pairs of engagement members positioned at forward and rearward ends of the base, the over-center cam assembly being operable to selectively lock or release each of the pair of base legs in the front position and the rear position.

5. The portable lifting machine of claim 2, wherein:
each of the pair of base legs is couplable to an upper surface of the base using an omnidirectional pivot assembly.

6. The portable lifting machine of claim 2, wherein:
each of the pair of base legs includes a first portion couplable to the base at a proximal end, a second portion extending perpendicular from a distal end of the first portion, and a third portion extending perpendicularly from the second portion, wherein the first portion and the third portion are parallel.

7. The portable lifting machine of claim 1, further comprising:
a pair of outrigger legs rotatably coupled to the base on opposite sides of the mast, each of the pair of outrigger legs including a distal end with a wheel.

8. The portable lifting machine of claim 7, wherein:
each of the pair of outrigger legs is movable between and lockable in a forward position, a rearward position, and an angled position, the forward position extending forward of the mast and the rearward position extending rearward of the mast.

9. The portable lifting machine of claim 7, wherein:
each of the pair of outrigger legs is couplable to respective side surfaces of the base using a bidirectional pivot.

10. The portable lifting machine of claim 1, wherein:
the base includes a pair of frame rails positioned on opposite sides of the mast and a plurality of wheels, each of the plurality of wheels coupled at opposite ends of each of the pair of frame rails.

11. The portable lifting machine of claim 10, wherein:
each of the pair of frame rails comprising a fork passageway defined therethrough, the fork passageway configured to receive a fork of a forklift.

12. The portable lifting machine of claim 1, wherein:
the mast includes a front side and a rear side; and
the load lifting assembly includes a lift support for lifting the load and a lifting mechanism for manipulating the plurality of telescoping portions, the lift support coupled to the front side of the mast, the lifting mechanism coupled to the rear side of the mast.

13. The portable lifting machine of claim 12, wherein:
the lifting mechanism comprises a winch configured to be actuated using a manual crank input or a drill input.

14. The portable lifting machine of claim 1, further comprising:
at least one support strut coupled between the base and the mast.

15. The portable lifting machine of claim 14, further comprising:
a support frame coupled to one of the plurality of telescoping portions of the mast, the support frame configured to receive the at least one support strut for positioning the mast in one or more discrete positions relative to the base, the one or more discrete positions including a vertical position with the mast positioned substantially vertical relative to the base and a stored position with the mast positioned substantially parallel to the base.

16. The portable lifting machine of claim 15, wherein:
the support frame includes a guide structure and a collar movable along the guide structure for positioning the mast in the one or more discrete positions, the at least one support strut coupled to the collar.

17. The portable lifting machine of claim 1, further comprising:
a mast hold-down mechanism extending from the base, the mast hold-down mechanism configured to engage at least one of the plurality of telescoping portions for preventing movement of the plurality of telescoping portions.

18. A portable lifting machine for lifting a load, the portable lifting machine comprising:
a base;
a mast coupled to the base; and
a fork passageway defined through base, the fork passageways configured to receive forks of a forklift for lifting and transporting the portable lifting machine.

19. The portable lifting machine of claim 18, wherein:
the base includes a pair of frame rails positioned on opposite sides of the mast; and
the fork passageway is defined through each of the pair of frame rails.

20. A portable lifting machine for lifting a load, the portable lifting machine comprising:
a base;
a pair of base legs pivotally coupled to the base on opposite sides of a mast, each of the pair of base legs including a distal end with a wheel and being movable between a front position and a rear position; and
a counterweight selectively couplable to the pair of base legs when in the rear position to stabilize the portable lifting machine during lifting or transport operations.
